(19) United States
(12) Patent Application Publication
(10) Pub. No.: US 2008/0227383 A1
(43) Pub. Date: Sep. 18, 2008

(54) DIGITAL CONTENT TRANSMITTING APPARATUS, DIGITAL-CONTENT CONTROL WEB PAGE DATA TRANSMITTING APPARATUS, AND METHODS OF CONTROLLING OPERATION OF SAME

(76) Inventor: Akira HINO, Asaka-shi (JP)

Correspondence Address: BIRCH STEWART KOLASCH & BIRCH, PO BOX 747, FALLS CHURCH, VA, 22040-0747, US

(21) Appl. No.: 12/047,980

(22) Filed: Mar. 13, 2008

(30) Foreign Application Priority Data
Mar. 15, 2007 (JP) 2007-065957

(51) Int. Cl. H04H 20/71

(52) U.S. Cl. 455/3.01

(57) ABSTRACT

Content control information corresponding to the model of a mobile telephone that has requested a moving picture file is transmitted to this mobile telephone. When the moving picture file is requested by the mobile telephone, the model of the mobile telephone is specified by a model specifying unit. Content control information indicating handling of the requested moving picture file is read from a content control information database, and a control data generating unit generates control data from the content control information in a format conforming to the specified model. The control data conforming to the model of the mobile telephone and the requested moving picture file are transmitted to the mobile telephone.

### BACKGROUND OF THE INVENTION

1. Field of the Invention

This invention relates to an apparatus for transmitting digital content, an apparatus for transmitting web page data for controlling digital content, and a method of controlling operation of such apparatus.

2. Description of the Related Art

Digital content can be received by not only a personal computer but also by a mobile telephone or the models available, there are instances where the format (bit rate, etc.) of the digital content is converted in accordance with the model that receives the content, and the digital content obtained by the conversion is transmitted to the mobile telephone (see the specifications of Japanese Patent Application Laid-Open Nos. 2001-195335 and 2003-319365).

Further, there are also arrangements in which provided information, which includes icon information composed of image information and related information containing information that defines processing related to the image information, is adapted so as to conform to the processing capability of a terminal device (see the specification of Japanese Patent Application Laid-Open No. 2003-162476).

In digital content such as moving picture data, digital-content control information indicating how a terminal device that has received this moving picture data is to handle the data often differs from one terminal device to another. Consequently, the handling of digital content cannot be changed for every terminal device if only the digital content is subjected to a format conversion for every terminal device. Further, there are instances where digital-content control information has a description format and description location that depend upon the terminal device.

### SUMMARY OF THE INVENTION

An object of the present invention is to change digital-content control information in accordance with a terminal device.

According to a first aspect of the present invention, the foregoing object is attained by providing a digital content transmitting apparatus comprising: a receiving device (means) for receiving a digital-content transmit request, which is a transmit request transmitted from a transmission requesting terminal device; a model detection device (means) for detecting the model of the transmission requesting terminal device that transmitted the transmit request received by the receiving device; a digital-content control information search device (means) for finding digital-content control information corresponding to the model detected by the model detection device and regarding digital content the transmission of which has been requested by the transmission requesting terminal device, the digital-content control information being found from a digital-content control information database in which digital-content control information, which corresponds to every model of transmission-target terminal device to which digital content is to be transmitted and which controls handling of the digital content, has been stored; a digital content search device (means) for finding digital content, which corresponds to the transmit request received by the receiving device, from a digital content database in which digital content has been stored; and a transmitting device (means) for transmitting the digital content found by the digital content search device and the digital-content control information found by the digital-content information detection device to the transmission requesting terminal device.

The first aspect of the present invention also provides an operation control method suited to the above-described digital content transmitting apparatus. Specifically, the first aspect of the present invention also provides a method of controlling operation of a digital content transmitting apparatus, the method comprising the steps of: receiving a digital-content transmit request, which is a transmit request transmitted from a transmission requesting terminal device; detecting the model of the transmission requesting terminal device that transmitted the transmit request received; finding digital-content control information corresponding to the detected model and regarding digital content the transmission of what has been requested by the transmission requesting terminal device, the digital-content control information being found from a digital-content control information database in which digital-content control information, which corresponds to every model of transmission-target terminal device to which digital content is to be transmitted and which controls handling of the digital content, has been stored; finding digital content, which corresponds to the received transmit request, from a digital content database in which digital content has been stored; and transmitting the found digital content and the found digital-content control information to the transmission requesting terminal device.

In accordance with the first aspect of the present invention, the model of a terminal device that requests transmission is detected. Digital-content control information corresponding to the detected model and requested digital content is found from a digital-content control information database. Further, digital content corresponding to the transmit request from the transmission requesting terminal device is found from a digital content database. The found digital-content control information and found digital content are transmitted to the transmission requesting terminal device. The digital content transmitting apparatus is capable of transmitting digital-content control information, which corresponds to the model, to the terminal device that requests the transmission.

Digital content may be stored in the digital content database in association with the model of the transmission requesting terminal device. In this case, the digital content search device would find digital content, which corresponds to the model of the transmission requesting terminal device detected by the model detection device, from the digital content database.

In accordance with a second aspect of the present invention, the foregoing object is attained by providing an apparatus for transmitting web page data for controlling digital content, the apparatus comprising: an embed-position detection device (means), to which prototype web page data representing a prototype of a web page is input, for detecting a position at which link data, which indicates a link destination of digital content in the prototype web page represented by the prototype web page data that has been input, and digital-content control information, which controls handling of the digital content, are to be embedded; a receiving device (means) for receiving, from a transmission requesting terminal device, a request to transmit digital-content control web page data; a generating device (means), responsive to the transmit request received by the receiving device, for generating digital-content control web page data by embedding the link data and the digital-content control information, the latter in conformity with the transmission requesting terminal device, at the position detected by the embed-position detection device; and a transmitting device (means) for transmitting the digital-content control web page data generated by the generating device to the transmission requesting terminal device.

The second aspect of the present invention also provides an operation control method suited to the above-described apparatus for transmitting web page data for controlling digital content. Specifically, the second aspect of the present invention provides a method of controlling operation of an apparatus for transmitting web page data for controlling digital content, the method comprising the steps of: inputting prototype web page data representing a prototype of a web page and detecting a position at which link data, which indicates a link destination of digital content in the prototype web page represented by the prototype web page data that has been input, and digital-content control information, which controls handling of the digital content, are to be embedded; receiving, from a transmission requesting terminal device, a request to transmit digital-content control web page data; in response to the transmit request received, generating digital-content control web page data by embedding the link data and the digital-content control information, the latter in conformity with the transmission requesting terminal device, at the detected position; and transmitting the generated digital-content control web page data to the transmission requesting terminal device.

In accordance with the second aspect of the present invention, a position at which link data and digital-content control information are to be embedded is detected. The link data indicates the link destination of digital content in the prototype web page represented by the prototype web page data. If a transmission requesting terminal device issues a request to transmit digital-content control web page data, the link data and digital-content control information are embedded at the detected embed position. The digital-content control web page data in which the link data and digital-content control information have been embedded is transmitted to the transmission requesting terminal device. Digital-content control web page data in which digital-content control information corresponding to the transmission requesting terminal device has been embedded can be transmitted to this terminal device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a moving picture transmitting apparatus;

FIG. 2 illustrates an example of content control information;

FIG. 3 illustrates an example of model attribute information;

FIG. 4 illustrates a control data generating unit; and

FIGS. 5A and 5B illustrate a prototype web page and a content control web page, respectively.

### DESCRIPTION OF THE PREFERRED EMBODIMENT

A preferred embodiment of the present invention will now be described in detail with reference to the drawings.

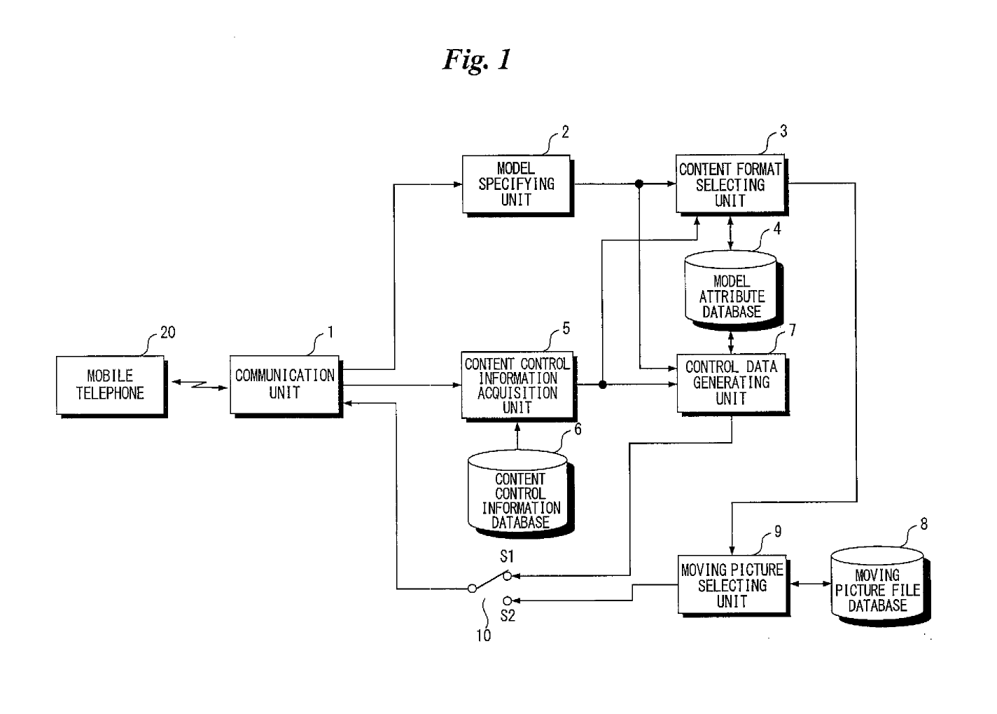

FIG. 1 is a block diagram illustrating the electrical configuration of a moving picture transmitting apparatus according to an embodiment of the present invention.

The moving picture transmitting apparatus according to this embodiment transmits a moving picture file, which has a format conforming to the model of a mobile telephone (transmission requesting terminal device) that has requested a moving picture file (although the request is not limited to a moving picture file and may be a request for digital content, a still image file, etc.), to this mobile telephone, and also transmits content control information indicating handling of this moving picture file to the mobile telephone, the control information conforming to the model of the mobile telephone. Thus, not only a moving picture file but also content control information conforming to the model of a mobile telephone to which a transmission is to be made can be transmitted to this mobile telephone.

A transmit-request file representing a request to transmit a moving picture is transmitted from a mobile telephone 20 to a moving picture transmitting apparatus. The transmit-request file transmitted from the mobile telephone 20 is received by a communication unit 1 of the moving picture transmitting apparatus.

Header information contained in the transmit-request file received by the communication unit 1 is input to a model specifying unit 2. The header information includes a user agent, which the model specifying unit 2 utilizes to specify the model of the mobile telephone 20. Data indicating the model of the mobile telephone 20 is input to a content format selecting unit 3 and control data generating unit 7.

The information in the main portion of the transmit-request file is input to a content control information acquisition unit 5. On the basis of this input information of the main portion of the file, the content control information acquisition unit 5 specifies the moving picture file requested by the mobile telephone 20. For example, in a case where an URL (Uniform Resource Locator) indicating the storage destination of the moving picture file requested by the mobile telephone 20 has been recorded in the main portion of the transmit-request file, the moving picture file requested by the mobile telephone 20 can be specified from the URL. Further, a content control information database 6 is connected to the content control information acquisition unit 5. Content control information that decides the handling of moving picture files has been stored in the content control information database 6 in association with respective ones of the moving picture files. Content control information corresponding to the moving picture file requested by the mobile telephone 20 is read from the content control information database 6 by the content control information acquisition unit 5. Data indicating the moving picture file requested by the mobile telephone 20 and specified by the content control information acquisition unit 5 is input to the content format selecting unit 3. The content control information acquired by the content control information acquisition unit 5 is input to the control data generating unit 7.

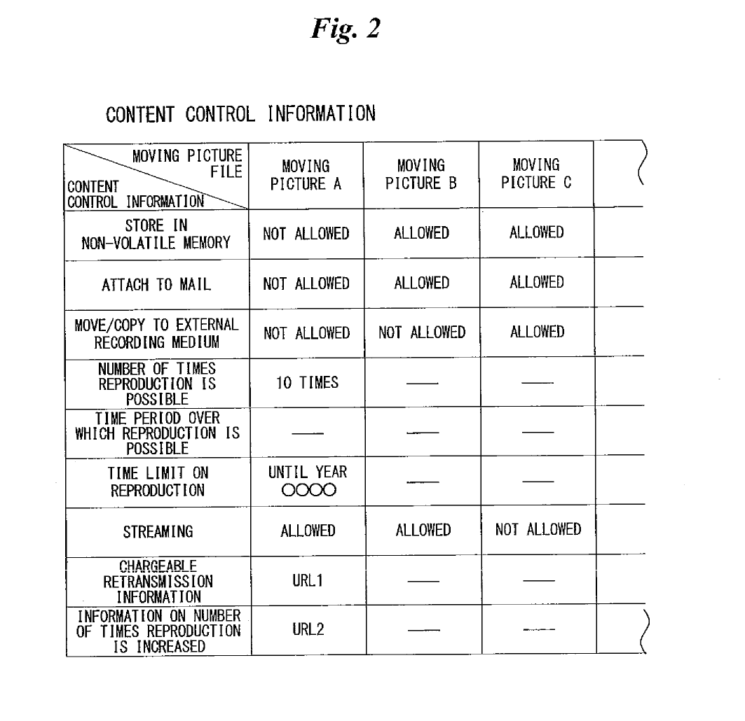

FIG. 2 illustrates an example of content control information that has been stored in the content control information database 6.

Content control information has been stored in the content control information database 6 for every moving picture file, as mentioned above. The content control information includes whether or not to store a moving picture file in a non-volatile memory of the mobile telephone that received the file; whether or not to attach the received moving picture file to e-mail; whether or not to move or copy the received moving picture file to an external recording medium; number of times the received moving picture file has been reproduced; time period over which the received moving picture file can be reproduced; time limit on reproduction of the received moving picture file; whether or not streaming of the received moving picture file is allowed; chargeable retransmission information regarding the received moving picture file; and information regarding an increase in number of times the received moving picture file is reproduced. The chargeable retransmission information is information that makes it possible for a moving picture represented by a moving picture file to be viewed upon paying a fee by accessing the web page of a specific URL. The specific URL is described in the information. The information regarding an increase in number of times the received moving picture file is reproduced is information that makes it possible to increase the number of times playback is performed by accessing the web page of a specific URL. The specific URL is described in the information.

From among such content control information that has been stored in the content control information database 6, content control information corresponding to the requested moving picture file is read by the content control information acquisition unit 5.

With reference again to FIG. 1, data representing the model that has been output from the model specifying unit 2 and the moving picture file that has been output from the content control information acquisition unit 5 are input to the content format selecting unit 3, as mentioned above. Further, a model attribute database 4 is connected to the content format selecting unit 3. Model attribute information representing the format of a moving picture file has been stored in the model attribute database 4 for every model of transmission-target terminal device. From among the model attribute information that has been stored in the model attribute database 4, model attribute information corresponding to the model specified by the model specifying unit 2 is read out of the model attribute database 4.

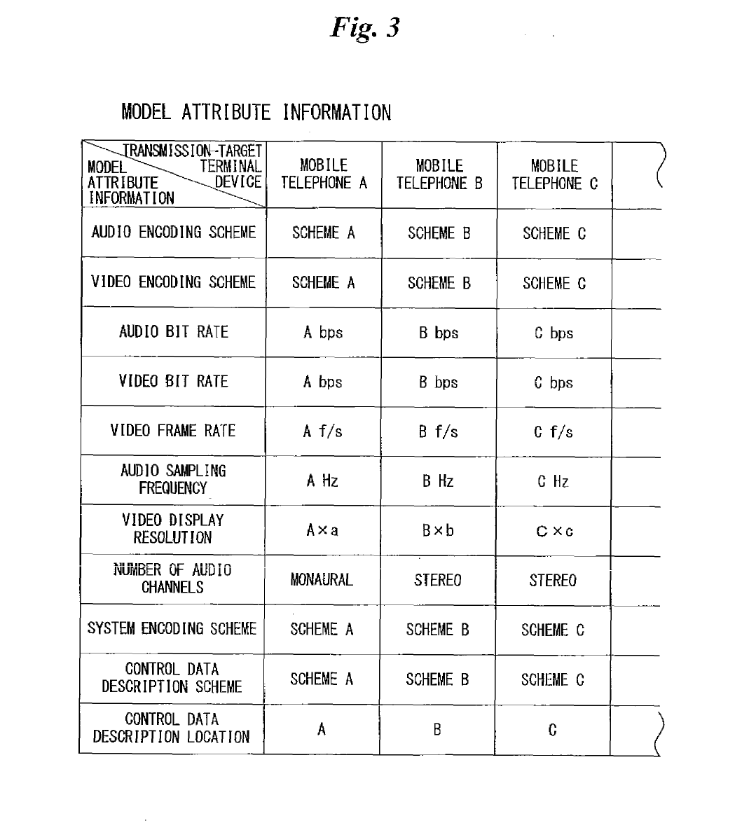

FIG. 3 illustrates an example of model attribute information that has been stored in the model attribute database 4.

The model attribute information includes an audio encoding scheme of audio data representing audio that has been added to a moving picture; a video encoding scheme of video data representing the motion of the moving picture; audio bit rate; video bit rate; video frame rate; audio sampling frequency; video display resolution; number of audio channels; system encoding scheme (audio and video multiplexing scheme); control data description scheme; and control data description location (e.g., inside a moving picture file, on a web page linked to a moving picture, in a communication protocol, etc.). These items of model attribute information have been stored in the model attribute database 4 for every model of transmission-target terminal device.

With reference again to FIG. 1, with regard to a requested moving picture file, a moving picture selecting unit 9 is controlled by the content format selecting unit 3 in such a manner that a moving picture file corresponding to the model attribute information of the specified model is read from a moving picture file database 8. For example, if we assume that a moving picture requested by the mobile telephone 20 is “Moving Picture A” and that the model of the mobile telephone 20 is “Mobile Telephone A”, then a moving picture file indicating the content of “Moving Picture A” and having a format conforming to the model attribute information of “Mobile Telephone A” will be read by the moving picture selecting unit 9 from among the moving picture files that have been stored in the moving picture file database 8. It goes without saying that a number of moving picture files having formats corresponding to the transmission-target terminal device have been stored in the moving picture file database 8 even if the moving picture files are moving picture files having the same content. The moving picture file that has been read out of the moving picture file database 8 by the moving picture selecting unit 9 is applied to a terminal S2 of a changeover switch 10.

As described above, data representing a model that has been output from the model specifying unit 2 and content control information that has been output from the content control information acquisition unit 5 are input to the control data generating unit 7. Further, the control data generating unit 7 and model attribute database 4 are connected, and model attribute information corresponding to the specified model is input to the control data generating unit 7 from among the model attribute information that has been stored in the model attribute database 4. The control data generating unit 7 generates content control data [an HTML (HyperText Markup Language file) representing a content control web page] at a location that is in accordance with the control data description location, the input content control information being described by a scheme that is in accordance with the control data description scheme contained in the model attribute information corresponding to the specified model.

The changeover switch 10 is controlled by a changeover control circuit (not shown). By making a connection to a terminal S1, the content control data is applied to the communication unit 1 and is transmitted to the mobile telephone 20 by the communication unit 1. By making a connection to the terminal S2 of the changeover switch 10, the moving picture file is applied to the communication unit 1 and is transmitted to the mobile telephone 20 by the communication unit 1. Thus the moving picture represented by the moving picture file transmitted to the mobile telephone 20 is handled based upon the control information represented by the content control data transmitted to the mobile telephone 20. (That is, if the control information does not allow the moving picture file to be stored in the non-volatile memory, then this moving picture file cannot be stored in the non-volatile memory.)

Thus, not only is a moving picture file suited to a moving-picture reproduction format in a transmission requesting terminal device transmitted to this terminal device, but content control information corresponding to the model of the transmission requesting terminal device also can be transmitted to this terminal device.

In the above-described embodiment, the content control data is transmitted from the moving picture transmitting apparatus to the mobile telephone 20 as web page data. However, it may be so arranged that the content control data is simply transmitted to the mobile telephone 20 as data in the communication protocol and not as web page data. Further, it may be so arranged that a chargeable moving picture having a long playback time and a no-charge moving picture having a short playback time are prepared, and content control information in which the no-charge moving picture contains a link to the chargeable moving picture and the chargeable moving picture contains a link to the no-charge moving picture is stored in the content control information database 6.

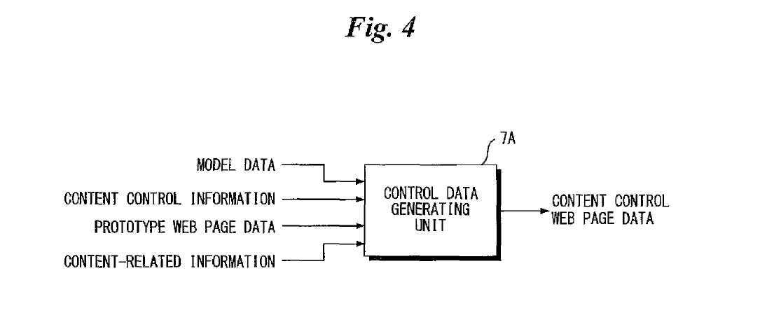

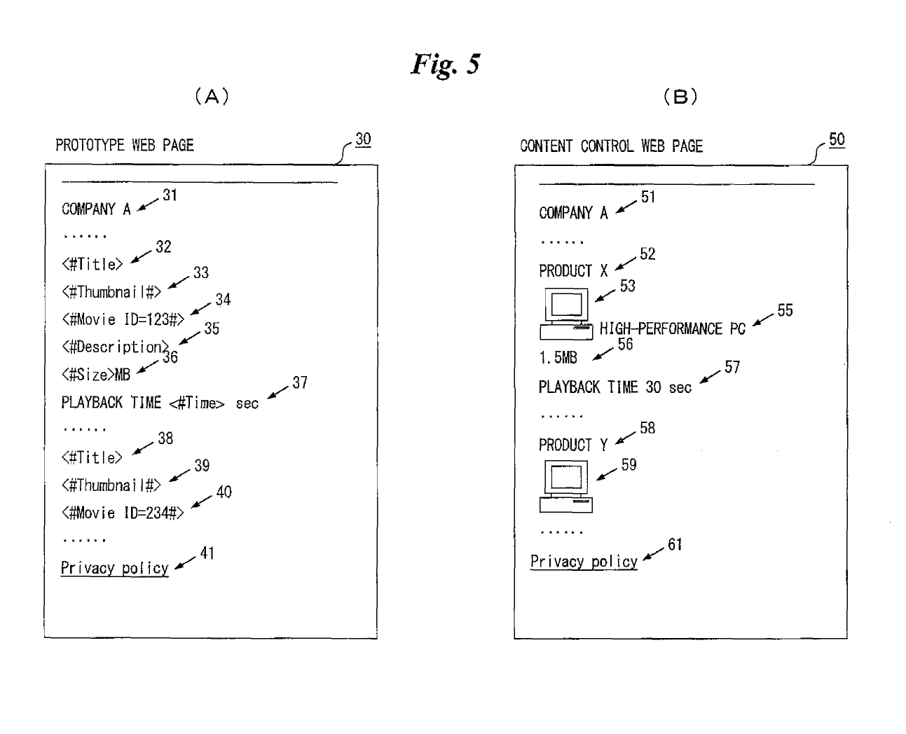

FIG. 4 and FIGS. 5A, 5B illustrate a modification. This modification makes it easier to view and to use a content control web page that includes the above-described content control information.

With reference to FIG. 4, prototype web page data and content-related information in addition to the above-described model data and content control data are input to a control data generating unit 7A. The latter generates content control web page data using the entered model data, content control data, prototype control data and content-related information. The generated web page data is transmitted to the mobile telephone 20 that requested the moving picture, as described above. The prototype web page data is a prototype for generating content web page data, as will be described in detail later. The content-related information is information such as the title, a still image representing the content of the moving picture, a description and the file size of the moving picture requested by the mobile telephone 20 as described above.

FIG. 5A illustrates an example of a prototype web page represented by prototype web page data.

A prototype web page 30 includes, in addition to a character string 31 of the name of the company providing the web page 30 and a character string 41 representing a privacy policy, character strings 32 and 38 reading T “<#Title>”, character strings 33 and 39 reading “<#Thumbnail#>”, character strings 34 and 40 reading “<#MovieID=123#>”, a character string 35 reading “<Description>”, a character string 36 reading “<#Size>MB”, and a character string 37 reading “Playback Time <#Time> sec”. Data (an HTML file) representing such a prototype web page is input to the control data generating unit 7A.

Content control web page data is generated in such a manner that character strings of titles included in the content information will be displayed at the positions of the character strings 32 and 38 reading “<#Title>”, still images will be displayed at the positions of the character strings 33 and 39 reading “<#Thumbnail#>”, and in such a manner that link data to the moving picture file specified by MovieID=123 as well as content control information will be embedded at the positions of the character strings 34 and 40 reading “<#MovieID=123#>”. Further, the content control web page data is generated in such a manner that a description will be displayed at the position of the character string 35 reading “<Description>”, the amount of data in the moving picture file specified by MovieID=123 will be displayed at the position of the character string 36 reading “<#Size>MB”, and playback time of the moving picture file specified by MovieID=123 will be displayed at the position of the character string 37 reading “Playback Time <#Time> sec”.

FIG. 5B illustrates an example of content control web page data represented by content control web page data generated in the control data generating unit 7A.

A content control web page 50 includes, in addition to a character string 51 of the name of a company and a character string 61 representing a privacy policy, in a manner similar to that of the prototype web page 30 described above, character strings 52 and 58 of titles (product name X and product name Y), still images 53 and 59, a character string 55 of a description (high-performance PC), a character string 56 indicating the size of the moving picture file, and a character string 57 indicating the playback time of the moving picture. It may be so arranged that the still image is extracted from the moving picture represented by the moving picture file.

Link data has been embedded at the position of the still image 53. By clicking the still image 53, the moving picture file at the link destination specified by the embedded link data is requested of the moving picture transmitting apparatus. Further, content control information also has been embedded at the position of the still image 53, although it does not appear on the content control web page. The handling of the moving picture file at the link destination is decided by this content control information. By transmitting the content control web page data from the moving picture transmitting apparatus to a mobile telephone, the content control web page 50 is displayed on the display screen of the mobile telephone (in such a manner that a request to transmit the content control web page is issued from the mobile telephone to the moving picture transmitting apparatus in advance). By clicking the still image 53, as mentioned above, a request is issued to transmit the moving picture file at the link destination specified by the link data that has been embedded, and the moving picture file is handled in accordance with the content control information that has been embedded at the position of the still image 53. If the content control information is in accordance with, e.g., HTML, then an object tag is embedded. Depending upon the object tag, control information can be represented by the bracketed parameters.

Although the above-described embodiment is implemented by hardware, it goes without saying that implementation may be by software as well. Further, the terminal device that transmits a moving picture file or the like is not limited to a mobile telephone and may be a personal computer or PDA (Personal Digital Assistant), etc.

As many apparently widely different embodiments of the present invention can be made without departing from the spirit and scope thereof, it is to be understood that the invention is not limited to the specific embodiments thereof except as defined in the appended claims.

What is claimed is:

1. A digital content transmitting apparatus comprising:
a receiving device for receiving a digital-content transmit request, which is a transmit request transmitted from a transmission requesting terminal device;
a model detection device for detecting the model of the transmission requesting terminal device that transmitted the transmit request received by said receiving device;
a digital-content control information search device for finding digital-content control information corresponding to the model detected by said model detection device and regarding digital content the transmission of which has been requested by said transmission requesting terminal device, the digital-content control information being found from a digital-content control information database in which digital-content control information, which corresponds to every model of transmission-target terminal device to which digital content is to be transmitted and which controls handling of the digital content, has been stored;
a digital content search device for finding digital content, which corresponds to the transmit request received by said receiving device, from a digital content database in which digital content has been stored; and
a transmitting device for transmitting the digital content found by said digital content search device and the digital-content control information found by said digital-content information detection device to the transmission requesting terminal device.

2. The apparatus according to claim 1, wherein digital content has been stored in the digital content database in association with models of the transmission requesting terminal device; and
said digital content search device finds digital content, which corresponds to the model of the transmission requesting terminal device detected by said model detection device, from the digital content database.

3. An apparatus for transmitting web page data for controlling digital content, said apparatus comprising:
an embed-position detection device, to which prototype web page data representing a prototype of a web page is input, for detecting a position at which link data, which indicates a link destination of digital content in the prototype web page represented by the prototype web page data that has been input, and digital-content control information, which controls handling of the digital content, are to be embedded;
a receiving device for receiving, from a transmission requesting terminal device, a request to transmit digital-content control web page data;
a generating device, responsive to the transmit request received by said receiving device, for generating digital-content control web page data by embedding the link data and the digital-content control information, the latter in conformity with the transmission requesting terminal device, at the position detected by said embed-position detection device; and
a transmitting device for transmitting the digital-content control web page data generated by said generating device to the transmission requesting terminal device.

4. A method of controlling operation of a digital content transmitting apparatus, said method comprising the steps of:
receiving a digital-content transmit request, which is a transmit request transmitted from a transmission requesting terminal device;
detecting the model of the transmission requesting terminal device that transmitted the transmit request received;
finding digital-content control information corresponding to the detected model and regarding digital content the transmission of which has been requested by the transmission requesting terminal device, the digital-content control information being found from a digital-content control information database in which digital-content control information, which corresponds to every model of transmission-target terminal device to which digital content is to be transmitted and which controls handling of the digital content, has been stored;
finding digital content, which corresponds to the received transmit request, from a digital content database in which digital content has been stored; and
transmitting the found digital content and the found digital-content control information to the transmission requesting terminal device.

5. A method of controlling operation of an apparatus for transmitting web page data for controlling digital content, the method comprising the steps of:
inputting prototype web page data representing a prototype of a web page and detecting a position at which link data, which indicates a link destination of digital content in the prototype web page represented by the prototype web page data that has been input, and digital-content control information, which controls handling of the digital content, are to be embedded;
receiving, from a transmission requesting terminal device, a request to transmit digital-content control web page data;
in response to the transmit request received, generating digital-content control web page data by embedding the link data and the digital-content control information, the latter in conformity with the transmission requesting terminal device, at the detected position; and
transmitting the generated digital-content control web page data to the transmission requesting terminal device.
